(19) United States
(12) Patent Application Publication
(10) Pub. No.: US 2010/0050360 A1
(43) Pub. Date: Mar. 4, 2010

(54) WIPER SECURING SEAT

(76) Inventor: MIN-HENG CHIANG, Wujie Township (TW)

Correspondence Address: LEONG C LEI, PMB # 1008, 1867 YGNACIO VALLEY ROAD, WALNUT CREEK, CA, 94598, US

(21) Appl. No.: 12/198,902

(22) Filed: Aug. 27, 2008

(51) Int. Cl. B60S 1/02; B60S 1/32

(52) U.S. Cl. 15/250.32; 15/250.43

(57) ABSTRACT

A wiper securing seat is disclosed. The securing seat comprises a left and right housing and a cap body. The front edge of the left and right housing is tapered, and adjacent to the front end, a stepped section is provided, and the stepped section is provided with a vertical plate body having an engagement hook. The rear section of the stepped section is a mounting slot, and the inner wall of the lateral side at the front and rear section of the left and right housing are provided with a perpendicular arranged front and rear engaging hook. Adjacent to the front engaging hook, a corresponding mounting sleeve and securing post is formed, and the cap body is provided with an opening corresponding to the plate body. After the left and right housing are mounted to the elastic plate of the soft wiper, the engaging hook and the securing post form into an engagement allowing the fastening shaft to be engaged at the mounting slot, and the cap is then mounted thereof.

### BACKGROUND OF THE INVENTION

(a) Technical Field of the Invention

The present invention relates to securing seat, and in particular, a securing seat for securing wiper onto wiper arm, which facilitates loading and unloading of wiper.

(b) Description of the Prior Art

FIGS. 1 and 2 show conventional wiper 1 structure comprising a securing seat 11 at the center thereof. The securing seat 11 is secured with the wiper arm and is driven the wiper to drive to-and-fro. The securing seat 11 is provided with an engaging hook 111, and a cap body 12 is provided with a sliding slot 12 corresponding to the engaging hook 111. After the wiper arm is mounted onto the securing seat 11, the sliding slot 121 is then mounted to the engaging hook 111. In FIG. 2, another wiper structure having a different securing seat 13 at the center thereof. The securing seat 13 has a mounting slot 131, and a cap body 14 is provided with even number pairs of engaging hooks 141 for mounting with the mounting slot 131. After the wiper arm is mounted to the securing seat 13, the engaging hook 141 is secured to the mounting slot 131. These conventional securing seats have the drawback that installation is complicated and the replacement of wiper is laborious. Accordingly, it is an object of the present invention to provide a securing seat for wiper which mitigates the above drawbacks.

### SUMMARY OF THE INVENTION

The primary purpose of the present invention is to provide a wiper securing seat comprising a left housing having a pointed and sloping front edge, adjacent to the front edge a stepped section formed with a perpendicular plate body having an engagement hook, the rear section of the stepped section being provided with a mounting slot, and a mounting sleeve formed at a place adjacent to the front engagement hook, the inner wall at the front lateral side being provided with a horizontal front engagement hook, and the inner wall of the rear lateral side being a vertical rear engagement hook; a right housing; and a cap body having a circular arch shape and having a surface provided with openings which correspond to the plate body at the right and left housing; thereby, in combination, the left and right housing are clipped onto the elastic plate of the soft wiper, and the front and rear engagement hook engages with each other, and the mounting sleeve is engaged with a positioning post of the wiper, forming into a securing seat, allowing the fastening shaft of the wiper arm to be inserted into the mounting slot, and then, the cap body covers the securing seat and the plate body is extended from the opening; the engaging hook is secured at the opening such that the wiper arm drives the soft wiper to move to and fro.

Yet still another object of the present invention is to provide a wiper securing seat comprising a left housing having a pointed and sloping front edge, adjacent to the front edge a stepped section formed with a perpendicular plate body having an engagement hook, the rear section of the stepped section being provided with a mounting slot, and a mounting sleeve formed at a place adjacent to the front engagement hook, the inner wall at the front lateral side being provided with a horizontal front engagement hook, and the inner wall of the rear lateral side being a vertical rear engagement hook; a right housing; and a cap body having a circular arch shape and having a surface provided with openings which correspond to the plate body at the right and left housing; a securing member which is an arch-shaped for mounting onto the fastening shaft of the wiper arm; thereby, in combination, the left and right housing are clipped onto the elastic plate of the soft wiper, and the front and rear engagement hook engages with each other, and the mounting sleeve is engaged with a positioning post of the wiper, forming into a securing seat, allowing the fastening shaft of the wiper arm to be inserted into the mounting slot, and then, the cap body covers the securing seat and the plate body is extended from the opening; the engaging hook is secured at the opening such that the wiper arm drives the soft wiper to move to and fro.

Still a further object of the present invention is to provide wiper securing seat, wherein the bottom edge of the left and right housing are respectively mounted with a semicircular post such that after the left and right housing are clipped, a circular post is formed, allowing the engagement at the through hole of the elastic plate of the wiper.

Another yet a further object of the present invention is to provide a wiper securing seat, wherein the front edge of the left and right housing is formed into an opened slot by having the end section being slanting in an arch shape forward the two lateral sides thereof, facilitating the mounting onto the wiper.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a conventional securing seat.

FIG. 2 is a perspective view of another conventional securing seat.

FIG. 3 is an exploded perspective view of the wiper securing seat of the present invention.

FIG. 4 is a perspective view of the wiper securing seat of the present invention.

FIGS. 5 and 6 illustrate schematically combination of the wiper securing seat of the present invention.

FIG. 7 is a schematic perspective view showing the mounting of the securing seat onto the wiper arm in accordance with the present invention.

FIG. 8 is another preferred embodiment showing the mounting of the securing seat onto the wiper arm in accordance with the present invention.

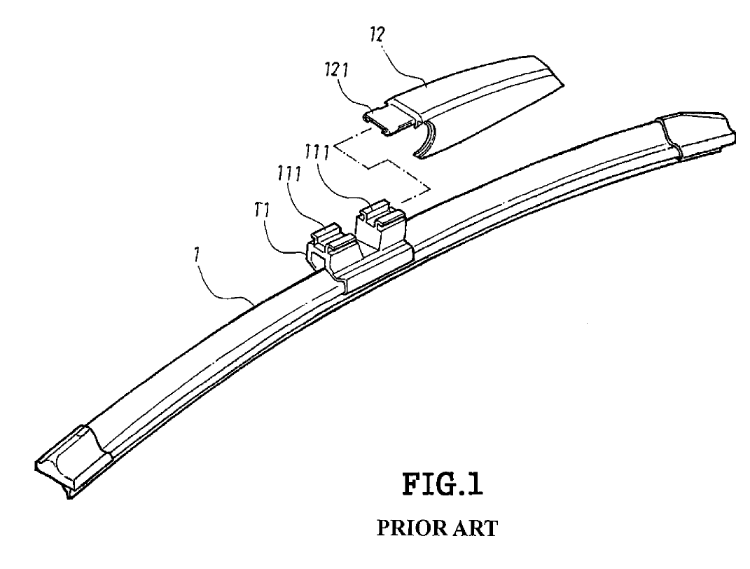

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

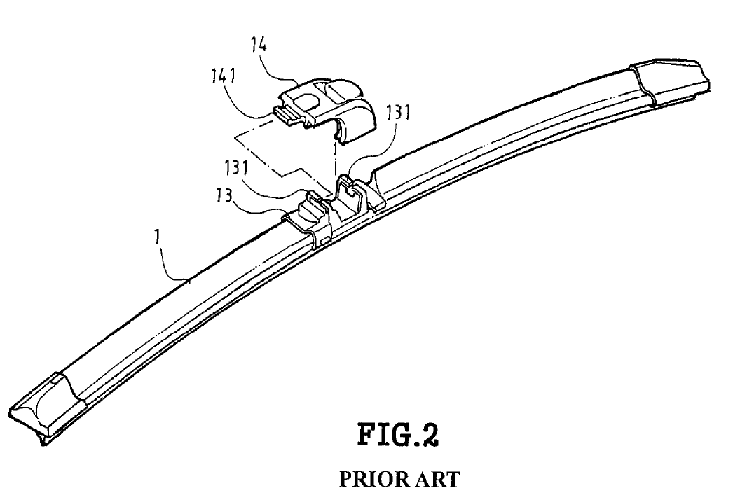

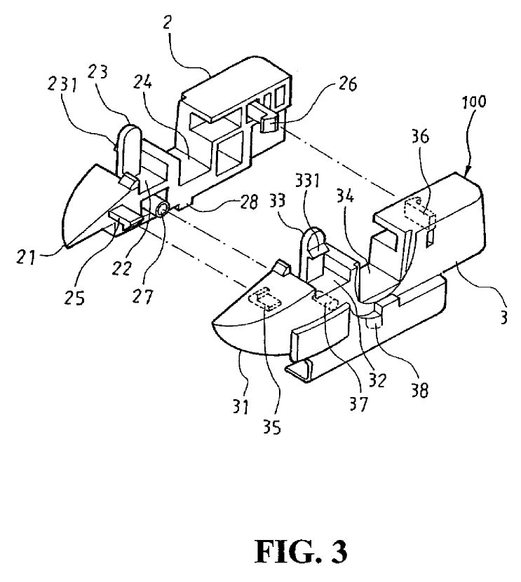

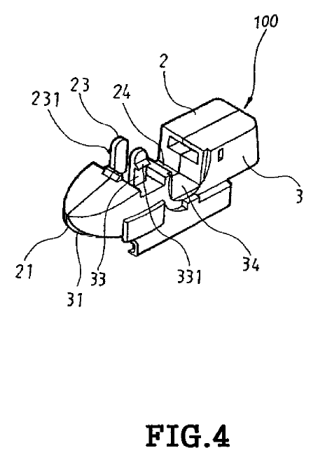

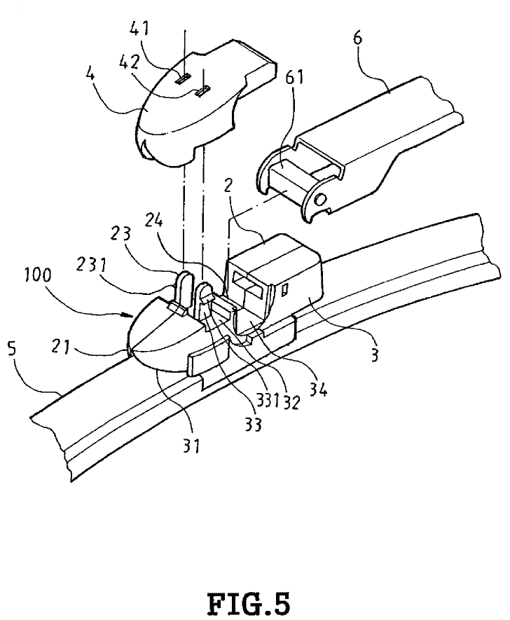

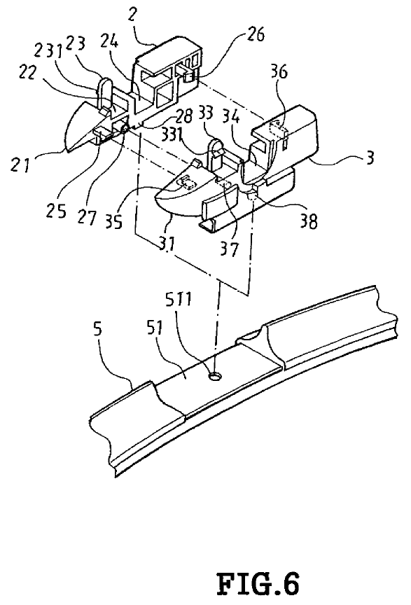

Referring to FIGS. 2 and 3, and with reference to FIGS. 5 and 6, the securing seat of the present invention comprises a left housing 2 and a right housing 3, and a cap 4. The front edge of the left and right housing 2, 3 is pointed and sloping from the pointed shaped end section to the sloping sections 21, 31, and adjacent to the front edge, stepped section 22, 32 are formed. The stepped sections 22, 32 are respectively provided with vertical plate body 23, 33, and the plate bodies 23, 33 are respectively provided with engaging hooks 231, 331. The rear section of the stepped section 22, 32 is provided with a mounting slot 24, 34.

The inner wall at the front lateral side of the left and right housing 2, 3 are provided with horizontal front engaging hooks 25, 35. The inner wall of the rear lateral side is provided with vertical rear engaging hooks 26, 36 such the front and rear engaging hooks 25, 35 are arranged at a degree of 90 to each other.

At the left housing 2, adjacent to the front engaging hook 25, a mounting sleeve 27 is provided. The right housing 3, adjacent to the front engaging hook 35, a securing post 37 corresponding to the mounting sleeve 27 is provided, and at the bottom edge of the left and right housing 2, 3, semicircular post body 28, 38 is respectively formed.

The cap body 4 which is circular, and sloping has a surface provided with openings 41, 42 corresponding to the plate body 23, 33 of the left and right housing 2, 3.

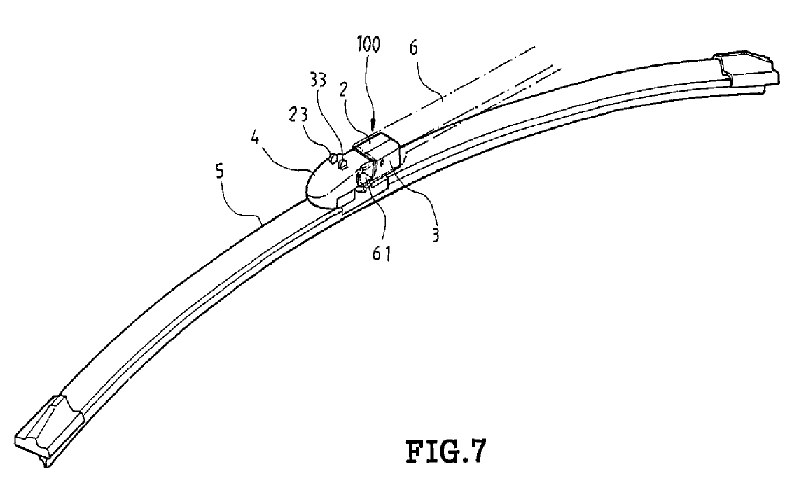

In accordance with the present invention, in combination, the left and right housing 2, 3 clip onto the elastic plate 51 of the soft wiper 5. The front hooks 25, 35, engage with the rear engaging hook 26, 36, and the mounting sleeve 27 is engaged with the securing post 37. The semicircular post bodies 28, 38 on the left and right housing 2, 3 form into the cylindrical post which is positioned onto the through hole 511 on the elastic plate 51 to form into a securing seat 100. The front edge of the left and right housing 2, 3 is pointed, and the pointed end section has sloping sections 21, 31 forming into an opening slot for mounting onto the soft wiper 5 so that the fastening shaft 61 is mounted into the mounting slot 24, 34. After that, it is capped using the cap body such that the plate bodies 23, 33 are exposed from the openings 41, 42. The engaging hooks 231, 331 are engaged at the openings 41, 42 such that the wiper arm 6 could drive the soft wiper 5 to move to and fro. Thus, the installation of the soft wiper 5 with the wiper arm 6 is convenient and fast. Referring to FIG. 7, in combination, the left and right housing 2, 3 clip onto the soft wiper 5 to allow the fastening shaft 61 to be mounted onto the mounting slot 24, 34 and then is capped using the cap body 4 and the plate bodies 23, 33 are exposed from the openings 41, 42. The engaging hooks 231, 331 are engaged with the openings 41, 42 and is therefore secured. The wiper arm 6 can be positioned on the top section of the securing seat 100, the wiper arm 6 drives the soft wiper 5 to move to and fro to wipe off water on windscreen. In combination, the fastening shaft 61 is placed inside the mounting slots 24, 34 and is then capped using the cap body 4, such that the installation of the soft wiper 5 to the wiper arm is convenient and rapid. Similarly, the replacement of soft wiper 5 is easy.

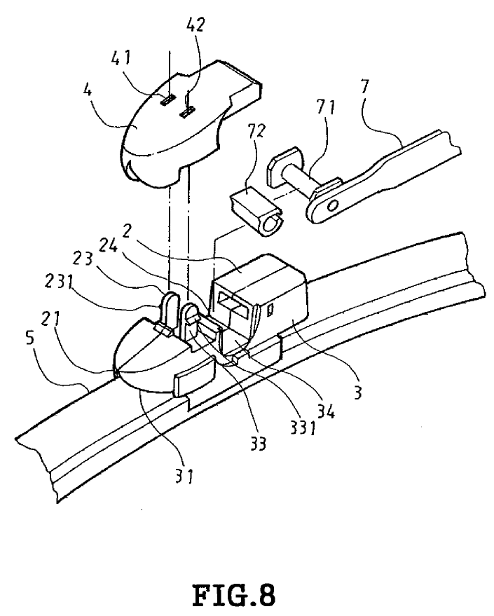

FIG. 8 shows different type of wiper arms making use of the securing seat of the present invention. As shown in the drawing, the securing seat can be used on fastening shaft 71 of different wiper arm 7. By incorporating of a securing member 72, it is engaged at the mounting slots 24, 34 of the left and right housing 2, 3 and is then capped using a cap body 4 such that the plate bodies 23, 33 are exposed via the openings 41, 42, and the engaging hooks 231, 331 hold the openings 41, 42. Thus, the wiper arm 7 can be positioned at the upper section of the securing seat 100, thus, the wiper arm 7 drives the soft wiper 5 to wipe off water on windscreen.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A wiper securing seat comprising
a left housing having a pointed and sloping front edge, adjacent to the front edge a stepped section formed with a perpendicular plate body having an engagement hook the rear section of the stepped section being provided with a mounting slot, and a mounting sleeve formed at a place adjacent to the front engagement hook, the inner wall at the front lateral side being provided with a horizontal front engagement hook, and the inner wall of the rear lateral side being a vertical rear engagement hook;
a right housing; and
a cap body having a circular arch shape and having a surface provided with openings which correspond to the plate body at the right and left housing;
thereby, in combination, the left and right housing are clipped onto the elastic plate of the soft wiper, and the front and rear engagement hook engages with each other, and the mounting sleeve is engaged with a positioning post of the wiper, forming into a securing seat, allowing the fastening shaft of the wiper arm to be inserted into the mounting slot, and then, the cap body covers the securing seat and the plate body is extended from the opening; the engaging hook is secured at the opening such that the wiper arm drives the soft wiper to move to and fro.

2. The wiper securing seat of claim 1, wherein the bottom edge of the left and right housing are respectively mounted with a semicircular post such that after the left and right housing are clipped, a circular post is formed, allowing the engagement at the through hole of the elastic plate of the wiper.

3. The wiper securing seat of claim 1, wherein the front edge of the left and right housing is formed into an opened slot by having the end section being slanting in an arch shape forward the two lateral sides thereof, facilitating the mounting onto the wiper.

4. A wiper securing seat comprising
a left housing having a pointed and sloping front edge, adjacent to the front edge a stepped section formed with a perpendicular plate body having an engagement hook the rear section of the stepped section being provided with a mounting slot, and a mounting sleeve formed at a place adjacent to the front engagement hook, the inner wall at the front lateral side being provided with a horizontal front engagement hook, and the inner wall of the rear lateral side being a vertical rear engagement hook;
a right housing; and
a cap body having a circular arch shape and having a surface provided with openings which correspond to the plate body at the right and left housing;
a securing member which is an arch-shaped for mounting onto the fastening shaft of the wiper arm;
thereby, in combination, the left and right housing are clipped onto the elastic plate of the soft wiper, and the front and rear engagement hook engages with each other, and the mounting sleeve is engaged with a positioning post of the wiper, forming into a securing seat, allowing the fastening shaft of the wiper arm to be inserted into the mounting slot, and then, the cap body covers the securing seat and the plate body is extended from the opening; the engaging hook is secured at the opening such that the wiper arm drives the soft wiper to move to and fro.

5. The wiper securing seat of claim 4, wherein the bottom edge of the left and right housing are respectively mounted with a semicircular post such that after the left and right housing are clipped, a circular post is formed, allowing the engagement at the through hole of the elastic plate of the wiper.

6. The wiper securing seat of claim 4, wherein the front edge of the left and right housing is formed into an opened slot by having the end section being slanting in an arch shape forward the two lateral sides thereof, facilitating the mounting onto the wiper.
